(19) United States
(12) Patent Application Publication
(10) Pub. No.: US 2026/0211750 A1
(43) Pub. Date: Jul. 23, 2026

(54) INTEGRATION SERVICES, AND ASSOCIATED SYSTEMS, METHODS, DEVICES, AND COMPUTER-READABLE MEDIA

(71) Applicant: LiveView Technologies, LLC, American Fork, UT (US)

(72) Inventors: Jason Glass, American Fork, UT (US); Steve Newell, American Fork, UT (US); Tyler Ray, American Fork, UT (US); Landon Stott, American Fork, UT (US)

(21) Appl. No.: 19/454,230

(22) Filed: Jan. 20, 2026

Related U.S. Application Data
(60) Provisional application No. 63/747,690, filed on Jan. 21, 2025.

(51) Int. Cl. G06F 9/54; H04L 9/40; H04L 67/02

(52) U.S. Cl. CPC G06F 9/541; H04L 63/08; H04L 67/02; G06F 2209/541

(57) ABSTRACT

Various embodiments relate to an integration service. In some embodiments, an integration service may configured to communicatively couple between a video management system and a device. The integration service may further configured to at least one of: translate a first simple object access protocol (SOAP) API call received from the video management system to a first representational state transfer (REST) API call; or translate a second REST API call received from the device to a second SOAP API. Associated systems, methods, units, and computer-readable media are also disclosed.

### PRIORITY CLAIM

This application claims the benefit of the filing date of U.S. Provisional Patent Application Ser. No. 63/747,690, filed Jan. 21, 2025, for “INTEGRATION SERVICES, AND ASSOCIATED SYSTEMS, METHODS, DEVICES, AND COMPUTER-READABLE MEDIA,” the disclosures which is hereby incorporated herein in its entirety by this reference.

### TECHNICAL FIELD

This disclosure relates generally to integration services, and to related units, systems, devices, methods, and computer-readable media. More specifically, some embodiments of the disclosure relate to translating between different protocols (e.g., API protocols) to enable communication between video management systems and devices using different calls (e.g., SOAP and REST API calls).

### BACKGROUND

Video management systems have traditionally operated as on-premise solutions utilizing established communication protocols for device integration and control. These systems typically employ Simple Object Access Protocol (SOAP) based application programming interfaces for communication with connected devices and services within their network infrastructure.

### BRIEF DESCRIPTION OF THE DRAWINGS

FIG. 1 depicts an example system, in accordance with one or more embodiments of the disclosure.

FIG. 2 depicts an example system, in accordance with one or more embodiments of the disclosure.

FIG. 3 is a simplified diagram of a system, according to various embodiments of the disclosure.

FIG. 4 is another illustration of an example system, in accordance with various embodiments of the disclosure.

FIG. 5 is a flowchart of an example method, according to various embodiments of the disclosure.

FIG. 6 is a flowchart of another example method, according to various embodiments of the disclosure.

FIG. 7 depicts another example system including a mobile unit, in accordance with various embodiments of the disclosure.

FIG. 8 depicts an example system including a mobile unit, a server, and one or more devices, in accordance with various embodiments of the disclosure.

FIG. 9 illustrates an example system, according to one or more embodiments of the disclosure.

### DETAILED DESCRIPTION

Referring in general to the accompanying drawings, various embodiments of the disclosure are illustrated to show example embodiments related to integration services, and associated systems, devices, methods, and computer-readable media. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

As noted above, on-premise video management systems, may employ Simple Object Access Protocol (SOAP) based application programming interfaces for communication with connected devices and services within their network infrastructure.

Cloud-based services and modern devices increasingly utilize Representational State Transfer (REST) application programming interfaces for communication. The evolution toward cloud-native architectures has resulted in a divergence between legacy on-premise video management platforms and contemporary cloud-enabled devices that operate through different communication protocols and network configurations.

API management systems have been developed to handle various communication protocols and service integrations, including hybrid cloud API management solutions and microservices-based identity management systems. Service onboarding frameworks have also been established to manage REST API communications and credential assignments for cloud services. However, these existing solutions typically address general API management or specific cloud service scenarios rather than the particular challenges of integrating legacy video management systems with modern cloud devices.

Mobile devices and cloud-connected sensors often operate on cellular networks with private IP addressing schemes, creating additional complexity for integration with traditional on-premise systems that are typically deployed behind corporate firewalls. The communication gap between SOAP-based legacy systems and REST-based cloud devices presents challenges for organizations seeking to integrate modern mobile surveillance units and cloud-enabled sensors with existing video management infrastructure.

Various embodiments of the disclosure may enable communication between legacy on-premise video management systems that utilize, for example, SOAP-based APIs and modern cloud devices that operate with, for example, REST-based APIs, particularly when such devices are deployed on networks (e.g., cellular networks) with private IP addresses.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to stationary units (e.g., stationary security/surveillance devices), such as a unit coupled to a stationary pole (e.g., a light pole), a structure (e.g., of a business or a residence), a tree, etc. Further, units and/or systems for indoor and/or outdoor use are within the scope of the disclosure.

Various embodiments may relate to an integration service that may enable a cloud native device (e.g., a cellular, private IP device) to be integrated with a video management system (e.g., a legacy on-premise video management system). The integration service may translate, for example, simple object access protocol (SOAP) API calls (e.g., for the ONVIF standard) to representational state transfer (REST) API calls. Further, the integration service may translate, for example, REST API calls to SOAP API calls. The integration service may also handle authentication (e.g., between devices (e.g., the cloud native device and the video management system)).

Various embodiments may modernize on-premise video management system (VMS) platforms by making VMS platforms REST API compatible. Various embodiments may not require additional infrastructure (e.g., from a customer), and various embodiments may be scalable to support enterprise-grade implementations.

A system may include an integration service, a video management system, and a device. The integration service (also referred to herein as a “proxy service” or “service”) is configured to communicatively couple between the video management system and the device, enabling communication between systems that utilize different communication protocols.

According to some embodiments, the integration service may be configured to translate a first simple object access protocol (SOAP) API call received from the video management system to a first representational state transfer (REST) API call. The SOAP API call may follow the ONVIF standard format and may include structured XML data that defines specific operations or requests from the video management system. When the integration service receives this SOAP API call, the integration service may parse the XML structure, extract the relevant parameters and operation details, and reformat this information into a REST API call format that can be understood by the target device. This translation process may involve converting the SOAP envelope structure into appropriate REST endpoints with corresponding HTTP methods and JSON payloads.

The integration service may be configured to translate a second REST API call received from the device to a second SOAP API call. When the device sends a REST API call including JSON-formatted data and HTTP methods, the integration service may process this information and convert it into the appropriate SOAP format expected by the video management system. This reverse translation ensures bidirectional communication capabilities between the two systems.

The integration service may further be configured to receive the first SOAP API call from the video management system and convey the first REST API call to the device. Upon receiving the SOAP API call, the integration service may establish a connection with the video management system, validate the incoming request, perform the necessary protocol translation, and transmit the converted REST API call to the designated device through appropriate network channels.

The integration service may also be configured to receive the second REST API call from the device and convey the second SOAP API call to the video management system. This process may involve accepting REST-formatted communications from the device, processing the contained information, converting it to SOAP format, and forwarding the translated call to the video management system for appropriate handling.

The integration service may include authentication capabilities to verify and authorize communication between the video management system and the device. The authentication process may include validating credentials (e.g., username and password) from the video management system, establishing secure communication channels, and maintaining session management throughout the communication process. The integration service stores authentication credentials and API access tokens, mapping device identifiers to corresponding IP addresses, port numbers, and authentication parameters.

In various embodiments, the device comprises a cloud device configured to receive the first REST API call. The cloud device operates within a cloud-based infrastructure and is specifically designed to handle REST-formatted communications. The system further includes a second device coupled to the cloud device, where the second device includes one or more components (e.g., input devices (e.g., cameras or other sensors), output devices (e.g., lights, speakers), without limitation). The integration service enables the video management system to control the one or more components device through the established communication pathway, allowing remote operation and management of component functionality.

In some embodiments, a component comprises a camera. The camera may include various types such as thermal cameras, infrared cameras, optical cameras, pan-tilt-zoom cameras, or bi-spectrum cameras. Through the integration service, the video management system can send control commands to adjust camera settings, initiate recording functions, modify camera positioning, or retrieve camera status information.

In some embodiments, the one or more components include at least one output device, and the integration service enables the video management system to control the at least one output device. The output devices may include lights such as flood lights or LED strobe lights, speakers for two-way public address systems, or electronic displays. The integration service facilitates remote control of these output devices by translating control commands from the video management system into appropriate formats that can be processed by the second device.

In one or more embodiments, the second device comprises a surveillance and/or security device (e.g., a mobile device). The mobile device may include a mobile security unit, mobile surveillance unit, or portable monitoring system that can be deployed in various locations. The mobile device typically includes a portable trailer, storage components, and a mast structure supporting various sensors and output devices. The integration service enables the video management system to maintain communication and control capabilities with the mobile device regardless of its physical location, provided network connectivity is available.

The integration service may operate by maintaining a mapping system that correlates device identifiers with network parameters including, for example, IP addresses, port numbers, usernames, and passwords. When processing API calls, the integration service may reference this mapping to determine the appropriate destination and authentication requirements for each communication. The service may handle both incoming ONVIF calls from video management systems and outgoing REST API calls to cloud-based devices, ensuring seamless interoperability between different system architectures and communication protocols.

In some embodiments, an integration service may be positioned between a video management system and a device to facilitate seamless communication through protocol translation. The integration service comprises a communication interface, a protocol translation engine, and an authentication module working together to enable interoperability between systems using different API protocols.

The communication interface of the integration service may establish bidirectional connections with both the video management system and the device. This interface monitors incoming communications from both endpoints and routes them to the appropriate processing components within the integration service. The interface maintains persistent connections to ensure reliable data transmission and supports multiple concurrent communication sessions.

The protocol translation engine may form the core component of the integration service and perform the critical function of converting between protocols (e.g., between SOAP and REST API protocols). For example, when the integration service receives a first SOAP API call from the video management system, the translation engine analyzes the structure and content of the SOAP message, extracts the relevant data and command parameters, and reformats this information into a corresponding REST API call structure. The translation process involves parsing the XML-based SOAP envelope, identifying the specific operation being requested, and mapping the SOAP elements to equivalent REST endpoints and parameters. The resulting first REST API call maintains the functional intent of the original SOAP request while conforming to REST architectural principles and formatting requirements.

The integration service then conveys the first REST API call to the device through its communication interface. The device, which operates natively with REST protocols, receives and processes this API call as if it originated from a REST-compatible system. This seamless translation allows the video management system to interact with cloud-based devices that may not support legacy SOAP protocols.

In the reverse direction, when the integration service receives a second REST API call from the device, the protocol translation engine performs the inverse conversion process. The engine parses the REST API structure, extracts the data payload and response information, and constructs a properly formatted SOAP API call. This translation involves creating the appropriate XML envelope structure, mapping REST response codes to SOAP fault elements where necessary, and ensuring that all data elements conform to SOAP messaging standards. The resulting second SOAP API call is then conveyed to the video management system through the communication interface.

The authentication module enhances security by verifying the identity and authorization of both the video management system and the device before processing any API translations. This authentication process may occur prior to each communication session and may involve credential verification, token validation, and/or certificate-based authentication depending on the security requirements of the connected systems. The authentication module may maintain secure credential storage and implement appropriate security protocols to protect against unauthorized access.

In some embodiments, the device comprises a cloud device that extends the integration service's functionality to control components of a second device. When the cloud device receives the first REST API call from the integration service, it processes the command and generates appropriate control signals for components connected to the second device. This architecture enables centralized management of distributed sensor networks through the video management system while maintaining the benefits of cloud-based processing and storage.

In another embodiment, the second device comprises a mobile unit including a number of components (e.g., including a camera), wherein the mobile surveillance system (i.e., including the mobile unit) can be managed through traditional video management software. The mobile unit receives control commands from the cloud device and operates a camera accordingly, capturing video data that can be streamed back through the integration service to the video management system. This configuration allows existing surveillance infrastructure to incorporate mobile units without requiring system-wide protocol upgrades.

The integration service may support metered connection architectures where bandwidth usage and data transmission costs are considerations. In one configuration, the integration service couples to the video management system via a first metered connection and couples to the device via a second metered connection, allowing independent monitoring and management of bandwidth usage for each connection. In an alternative configuration, the integration service couples to either the video management system or the device via at least one metered connection, providing flexibility in deployment scenarios where only one connection requires metered management.

In some embodiments, when the first REST API call targets control of electronic devices within a unit (e.g., a mobile unit), the integration service optimizes the communication path by routing the command through the cloud device, which maintains a metered connection to the mobile unit. This approach minimizes direct metered connection usage while ensuring reliable command delivery to the mobile unit's electronic devices. The cloud device acts as an intermediary, managing the metered connection efficiently and providing additional processing capabilities for complex device control operations.

The integration service may maintain translation tables and mapping configurations that define the correspondence between SOAP and REST API elements, ensuring consistent and accurate protocol conversion. These configurations may be updated to support new API versions or additional device types without requiring changes to the core translation engine. The service also implements error handling mechanisms that appropriately translate error conditions between protocols, ensuring that system administrators receive meaningful diagnostic information regardless of the underlying communication protocol used by each system component.

In some embodiments of a method, a proxy service facilitates communication between a video management system and a device by performing bidirectional API protocol translation and authentication services.

The method may include receiving a first simple object access protocol (SOAP) API call at the proxy service from a video management system. The video management system generates this SOAP API call according to the ONVIF standard, which may include operations such as PTZ. GetNodes to enumerate pan-tilt-zoom capabilities of connected devices. The proxy service acts as an intermediary web server that emulates the capabilities of an ONVIF-compatible camera, accepting these standardized SOAP-based web service calls from the video management system.

Upon receiving the first SOAP API call, the proxy service translates the SOAP API to a first representational state transfer (REST) API call. This translation process involves converting the XML-based SOAP envelope structure into a REST format that can be processed by modern cloud-native devices. The proxy service parses the incoming SOAP request, extracts the relevant parameters and operation details, and reformats this information into a corresponding REST API call structure. For example, an ONVIF PTZ. GetNodes SOAP request may be translated into an equivalent REST API call that can retrieve camera information from the target device's API.

The method further includes conveying the first REST API call from the proxy service to a device. In some embodiments, conveying the first REST API call to the device comprises conveying the first REST API call to a cloud device. The cloud device may represent a cellular or private IP device that operates on modern REST-based APIs rather than legacy SOAP protocols. This cloud device may communicatively couple to mobile surveillance units, security cameras, or other equipment that connects through cellular networks and/or private IP configurations.

In some embodiments, the method further includes conveying, responsive to receipt of the first REST API call at the cloud device, a control signal from the cloud device to a unit (e.g., a mobile surveillance unit) for controlling at least one sensor of the unit. The unit may include various components such as cameras, weather sensors, motion sensors, noise sensors, or chemical sensors, along with output devices like lights, speakers, or electronic displays. The control signal enables the video management system to remotely operate and configure these components through the proxy service translation layer.

In some embodiments, conveying the control signal comprises conveying the control signal to the unit via a metered connection. This metered connection typically involves cellular and/or satellite network communication where data usage is monitored and potentially charged based on consumption, making efficient data transmission protocols important for cost management and performance optimization.

Various embodiments support bidirectional communication by receiving a second REST API call at the proxy service from the device. This second REST API call may contain response data, status updates, or other information that needs to be communicated back to the video management system. The proxy service then translates the second REST API to a second SOAP API call, performing the reverse translation process to convert the modern REST format back into the SOAP protocol expected by the video management system. The method may further including conveying the second SOAP API call from the proxy service to the video management system, completing the bidirectional communication cycle.

In various embodiments, the method further comprises authenticating, via the proxy service, at least one of the video management system or the device. The authentication process may involve credential verification using username and password combinations for incoming ONVIF calls, while also managing API credentials for calls to the device's REST API. The proxy service maintains a mapping between device identifiers and their corresponding IP addresses, port numbers, usernames, and passwords, enabling secure communication between the legacy video management system and modern cloud-based devices. This authentication service may store both the basic authentication credentials for SOAP-based communications and the API credentials required for REST-based communications, ensuring secure and authorized access throughout the translation process.

Various embodiments may effectively modernize on-premise video management system platforms by making them REST API compatible without requiring additional customer infrastructure, while providing scalable support for enterprise-grade implementations through the proxy service architecture.

Embodiments of the disclosure will now be explained with reference to the accompanying drawings.

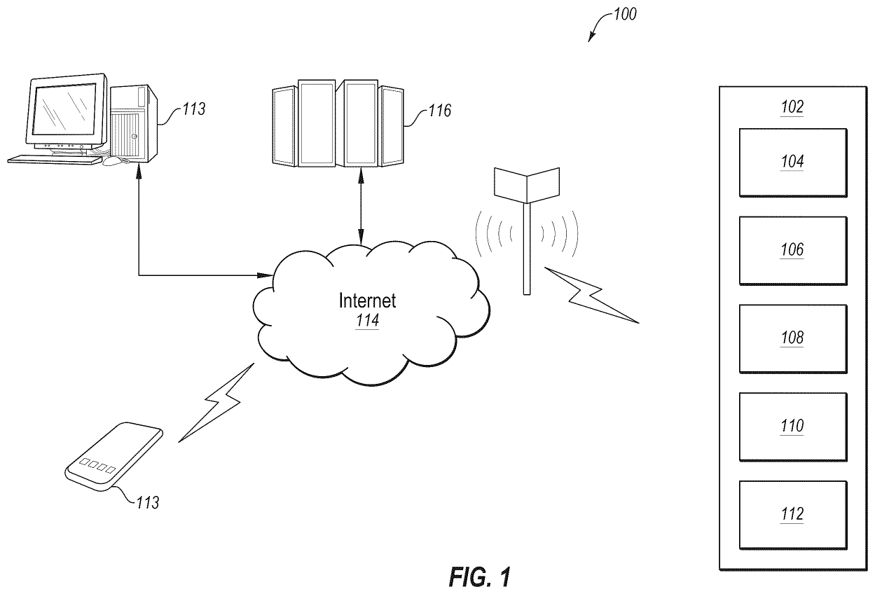

FIG. 1 illustrates a system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors (e.g., cameras, weather sensors, motion sensors, noise sensors, chemical sensors, without limitation) 104 and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., two-way public address (PA) speaker systems), any other suitable output device (e.g., a digital display), or any combination thereof.

In some embodiments, unit 102 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation, storage device 108 may continuously record data (e.g., video, images, i-frames, and/or other data) captured by one or more sensors 104 (e.g., cameras, lidar, radar, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Moreover, although not shown in FIG. 1, unit 102 may include one or more additional devices including, but not limited to, one or more microphones, one or more solar panels, one or more generators (e.g., fuel cell generators), or any combination thereof. Unit 102 may also include a communication device (e.g., a modem (e.g., a cellular modem, a satellite modem, a Wi-Fi modem, etc.)) 112, which may comprise any suitable and known communication device, which may be coupled to sensors 104, output devices 106, storage device 108, and/or computer 110 via wired connections, wireless connections, or a combination thereof. In some embodiments, communication device 112 may include one or more radios and/or one or more antennas.

System 100 may further include one or more electronic devices 113, which may comprise, for example only, a mobile device (e.g., mobile phone, tablet, etc.), a desktop computer, or any other suitable electronic device including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via the Internet 114.

According to various embodiments of the disclosure, unit 102 may be within a first location (a “camera location” or a “unit location”), and server 116 may be within a second location, remote from the first location. In addition, each electronic device 113 may or may not be remote from unit 102 and/or server 116. As will be appreciated by a person having ordinary skill in the art, system 100 may be modular, expandable, and/or scalable.

As noted above, in some embodiments, unit 102 may include a mobile unit (e.g., a mobile security/surveillance unit). In these and other embodiments, unit 102 may include a portable trailer (not shown in FIG. 1), a storage box (e.g., including one or more batteries) (not shown in FIG. 1), and a mast (not shown in FIG. 1) coupled to a head unit (e.g., including, for example, one or more cameras, one or more lights, one or more speakers, and/or one or more microphones) (not shown in FIG. 1). According to various examples, in addition to sensors and output devices, a head unit of unit 102 may include and/or be coupled to storage device 108, computer 110, and/or communication device 112.

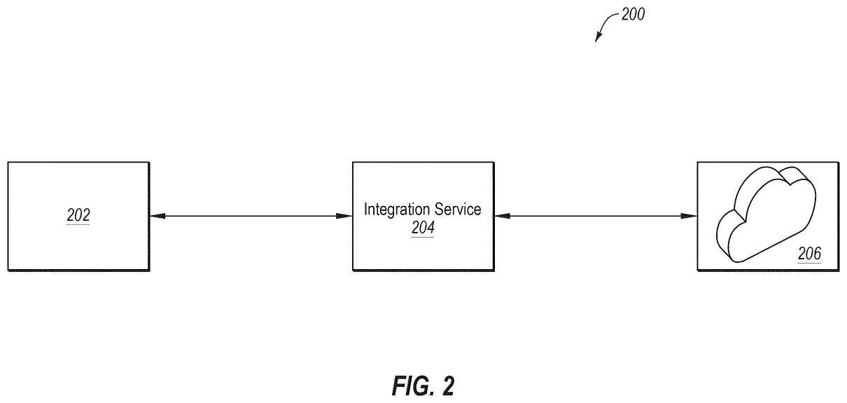

FIG. 2 depicts a system 200, according to various embodiments of the disclosure. System 200 includes a video management system (VMS) 202, an integration service 204, and a cloud device 206. For example, VMS 202 may be communicatively coupled to device 206 via integration service 204. For example, integration service 204 may be configured to handle authentication between VMS 202 and device 206. More specifically, for example, VMS 202 may be authenticated via credentials (e.g., username and password from VMS) and establish communication with device 206 via an application programming interface (API). For example, an entity, such as LiveView Technologies (LVT®), which may include a cloud platform (e.g., cloud device 206), may host integration service 204.

Integration service 204 may include authentication capabilities to verify and authorize communication between VMS 202 and device 206. The authentication process may include validating credentials (e.g., username and password) from VMS 202 and/or device 206, establishing secure communication channels, and maintaining session management throughout the communication process. Integration service 204 may store authentication credentials and API access tokens, mapping device identifiers to corresponding IP addresses, port numbers, and authentication parameters.

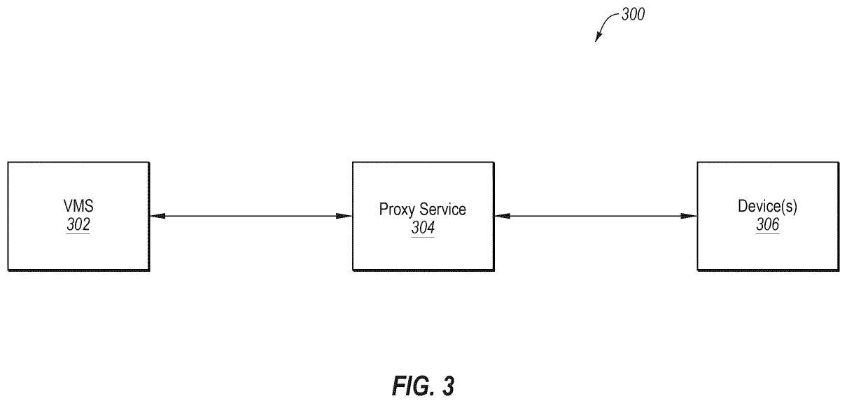

FIG. 3 is another illustration of a system 300, according to various embodiments of the disclosure. System 300 includes a video management system 302, a proxy service 304, and a device 306, which may include, for example, a server and/or a unit (e.g., unit 102 of FIG. 1).

In one example, a mapping service (e.g., service 204) may map an IP address & Port number to a device (e.g., a unit, such as unit 102). Further, the mapping service may use basic authentication (e.g., username and password) for incoming calls (e.g., ONVIF calls). Moreover, the mapping service may use API credentials for calls to an API (e.g., the LVT API). An authentication service (e.g., integration service 204) may store username & password for the mapping authentication, and store API credentials.

In one example, an integration service (e.g., integration service 204) may receive incoming ONVIF calls (e.g., SOAP based ONVIF call) and translate the received ONVIF calls to REST API calls. The service may also receive and translate incoming REST API calls to ONVIF (SOAP) calls. This service enables a mobile surveillance unit (e.g., including private IP address, cellular network) to interface with an on-premise system (networked, behind a firewall) by taking a port number and IP address, along with username and password, and mapping that to a set of API credentials.

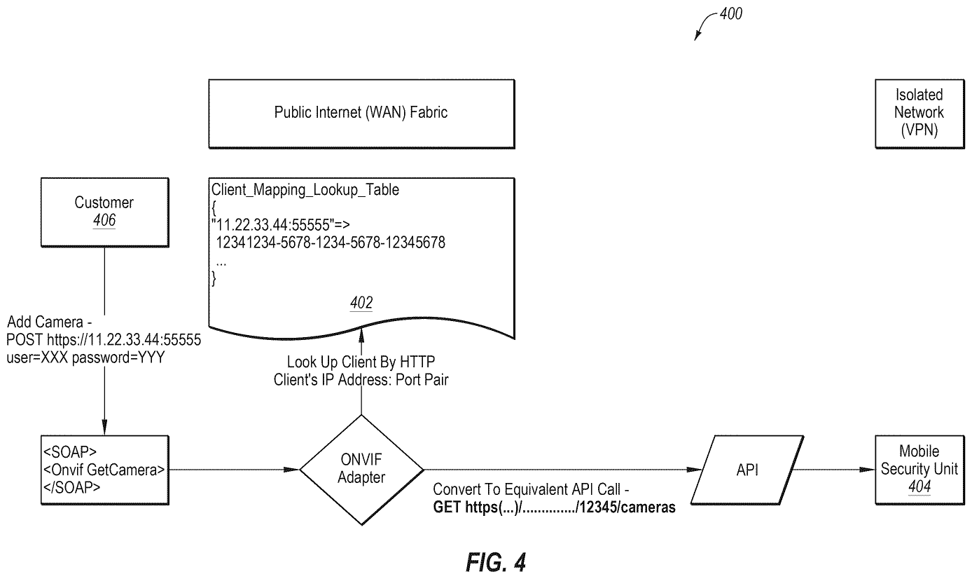

FIG. 4 is a more detailed illustration of a system 400 including an integration service 402, a unit 404 (e.g., a mobile unit), and a device (e.g., a VMS) 406.

In one example, a first entity (e.g., a customer (e.g., on premise) monitoring software (e.g., Genetec monitoring software)) (e.g., owner and/or operator of device 406), a units (e.g., a mobile security units) (e.g., unit 404) of a second, different entity are interfaced as though they were connections to cameras of the unit. The first entity's monitoring software may call, among other services, an ONVIF PTZ. GetNodes operation, to enumerate the pan-tilt-zoom (PTZ) capabilities of the unit (i.e., of the second entity). These calls may be processed by a server (e.g., of the second entity) running the second entity's ONVIF integration adapter solution.

Such a request, originating from software (e.g., of the first entity) and being placed to a web server (e.g., hosted by the second entity) (emulating a selection of the capabilities of an ONVIF-compatible camera), may look like the following.

<? xml version = “1.0”?>
<SOAP-ENV:Envelope
xmlns:SOAP-ENV =
“http://www.w3.org/2001/12/soap-envelope”
SOAP-ENV:encodingStyle =
“http://www.w3.org/2001/12/soap-encoding”>
<SOAP-ENV:Body xmlns:m =
“http://www.onvif.org/ver10/ptz”>
<m:GetNodes>
<m:QuotationsName> MiscroSoft
</m:QuotationsName>
</m:GetQuotation>
</SOAP-ENV:Body>
</SOAP-ENV:Envelope>

The integration adapter may translate the above ONVIF SOAP web service call to pass-thru to the equivalent operation in the second entity's public API:

soapService.on(“ptz:GetNodes”, (context) => {
// make connection to LVT api
const client = await createL VTClient(auth: { . . . });
const nodes = await client
.getCameras( )
.map(lvtCamera => translateToOnvifNodeShape
(lvtCamera))
context.response.writeSoapEnvelope(nodes, 200);
});

The resulting exchange appears opaquely like a conventional SOAP-based ONVIF-compliant web camera.

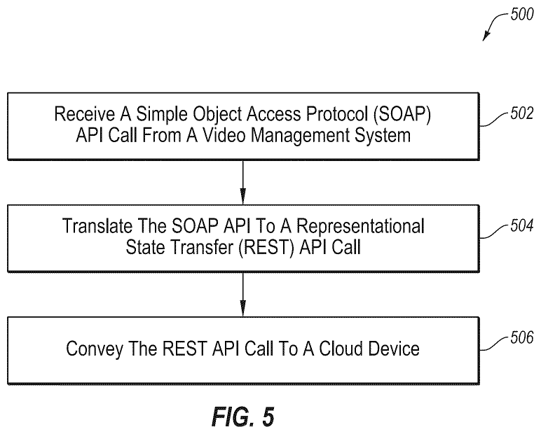

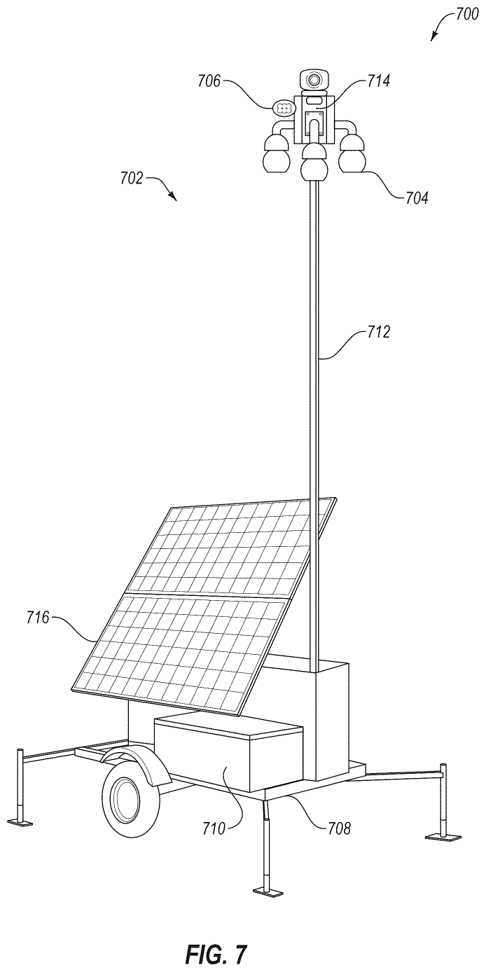

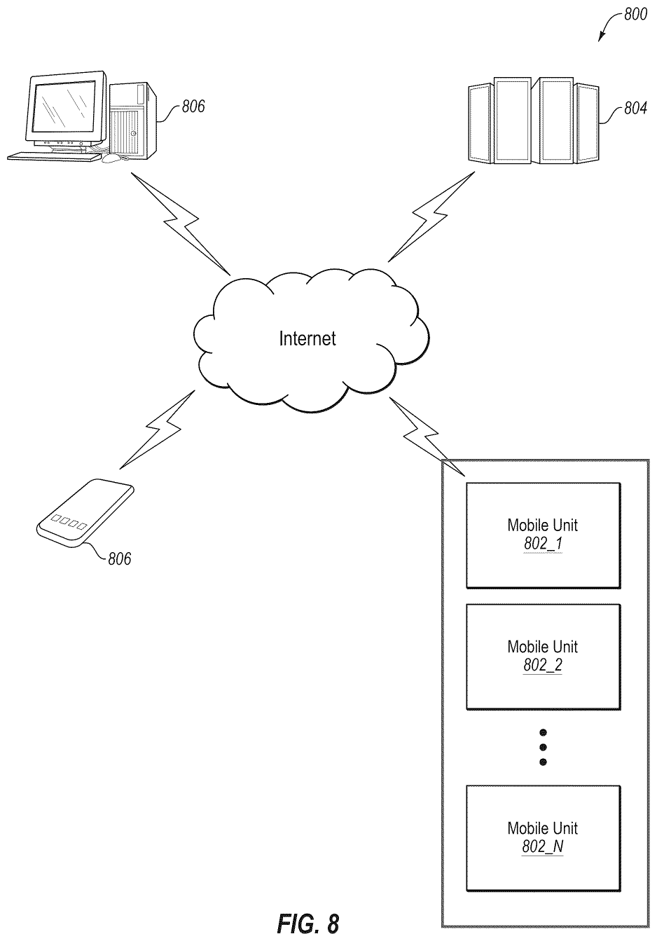

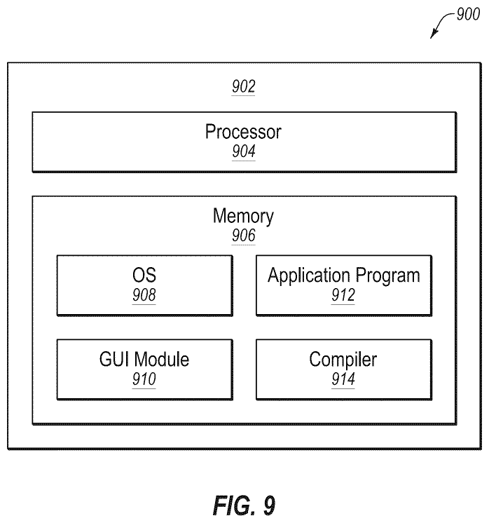

FIG. 5 is a flowchart of an example method 500. In some examples, method 500 may occur at each boot of the operating system. Method 500 may be arranged in accordance with at least one embodiment described in the disclosure. Method 500 may be performed, in some embodiments, by a device or system, such as system 100 (see FIG. 1), system 200 (see FIG. 2), system 300 (see FIG. 3), system 400 (see FIG. 4), system 700 (see FIG. 7), system 800 (see FIG. 8), system 900 (see FIG. 9), and/or another device or system. Although illustrated as discrete blocks, various blocks may be divided into additional blocks, combined into fewer blocks, or eliminated, depending on the desired implementation.

Method 500 may begin at block 502, wherein a simple object access protocol (SOAP) API call may be received, and method 500 may proceed to block 504. For example, the SOAP API call may sent from a video management system (e.g., video management system 202) and received at an integration service (e.g., integration service 204).

At block 504, the SOAP API may be translated to a representational state transfer (REST) API call, and method 500 may proceed to block 506. For example, an integration service (e.g., integration service 204) may translate the SOAP API call to the REST API call.

At block 506, the REST API call may be conveyed to a cloud device. For example, the REST API call may be conveyed from the integration service to cloud device 206.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 500 may include one or more acts wherein the video management system and/or the cloud device may be authenticated.

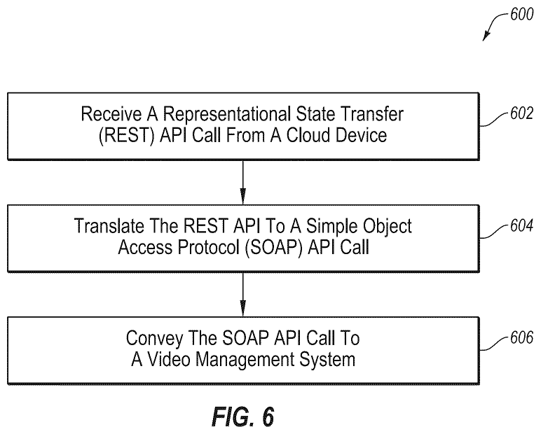

FIG. 6 is a flowchart of an example method 600. In some examples, method 600 may occur at each boot of the operating system. Method 600 may be arranged in accordance with at least one embodiment described in the disclosure. Method 600 may be performed, in some embodiments, by a device or system, such as system 100 (see FIG. 1), system 200 (see FIG. 2), system 300 (see FIG. 3), system 400 (see FIG. 4), system 700 (see FIG. 7), system 800 (see FIG. 8), system 900 (see FIG. 9), and/or another device or system. Although illustrated as discrete blocks, various blocks may be divided into additional blocks, combined into fewer blocks, or eliminated, depending on the desired implementation.

Method 600 may begin at block 602, wherein a representational state transfer (REST) API call may be received, and method 600 may proceed to block 604. For example, the REST API call may be sent from a device (e.g., cloud device 206) and received at an integration service (e.g., integration service 204).

At block 604, the REST API may be translated to simple object access protocol (SOAP) API call, and method 600 may proceed to block 606. For example, the integration service (e.g., integration service 204) may translate the REST API call to the SOAP API call.

At block 606, the SOAP API call may be conveyed to a device. For example, the SOAP API call may be conveyed from the integration service to a video management system (e.g., video management system 202).

Modifications, additions, or omissions may be made to method 600 without departing from the scope of the present disclosure. For example, the operations of method 600 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 600 may include one or more acts wherein the video management system and/or the cloud device may be authenticated.

FIG. 7 depicts another example system 700 including a unit 702, in accordance with various embodiments of the disclosure. Unit 702, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 702 may include one or more sensors (e.g., cameras, weather sensors, motion sensors, noise sensors, without limitation) 704 and one or more output devices 706 (e.g., lights, speakers, electronic displays, without limitation). Unit 702 may also include at least one storage device (e.g., internal flash media, a network attached storage device, or any other suitable electronic storage device), which may be configured for receiving and storing data (e.g., video, images, audio, without limitation) captured by one or more sensors of unit 702. According to some embodiments, unit 702 may include unit 102 of FIG. 1.

In some embodiments, unit 702 may include a mobile unit. In these and other embodiments, unit 702 may include a portable trailer 708, a storage box 710, and a mast 712 coupled to a head unit (also referred to herein as a “live unit,” an “edge device,” or simply an “edge”) 714, which may include (or be coupled to) for example, one or more batteries, one or more cameras, one or more lights, one or more speakers, one or more microphones, and/or other input and/or output devices. According to some embodiments, a first end of mast 712 may be proximate storage box 710 and a second, opposite end of mast 712 may be proximate, and possibly adjacent, head unit 714. More specifically, in some embodiments, head unit 714 may be coupled to mast 712 at an end opposite an end of mast 712 proximate storage box 710.

In some examples, unit 702 may include one or more primary batteries (e.g., within storage box 710) and one or more secondary batteries (e.g., within head unit 714). In these embodiments, a primary battery positioned in storage box 710 may be coupled to a load and/or a secondary battery positioned within head unit 714 via, for example, a cord reel.

In some embodiments, unit 702 may also include one or more solar panels 716, which may provide power to one or more batteries of unit 702. More specifically, according to some embodiments, one or more solar panels 716 may provide power to a primary battery within storage box 710. Although not illustrated in FIG. 7, unit 702 may include one or more other power sources, such as one or more generators (e.g., fuel cell generators) (e.g., in addition to or instead of solar panels). As will be appreciated, unit 702 may include one or controllers (e.g., within head unit 714) including one or more operating systems, which may be configured and/or updated in accordance with various embodiments disclosed herein.

FIG. 8 depicts a system 800, in accordance with various embodiments of the disclosure. System 800 includes one or more mobile units 802, a server 804, and one or more devices 806. In one non-limiting example, mobile unit 802 includes mobile unit 702 (see FIG. 7), server 804 may include a cloud server or any other server, and device(s) 806 may include an electronic device, such as a front-end device (e.g., a user device (e.g., mobile phone, tablet, etc.), a desktop computer, or any other suitable electronic device (e.g., including a display)). According to various embodiments, each of server 804 and device(s) 806 may be remote from mobile unit 802. Further, for example, server 804 may include a cloud-based processor.

According to various embodiments of the disclosure, mobile unit 802, which may include a modem, may be within a first location (a “camera location” or a “remote location”), and server 804 may be within a second location, remote from the camera location. In addition, in at least some examples, electronic device 806 may be remote from the camera location and/or server 804. As will be appreciated by a person having ordinary skill in the art, system 800 may be modular, expandable, and/or scalable.

FIG. 9 illustrates a system 900 that may be used to implement embodiments of the disclosure. System 900 may include a computer 902 that comprises a processor 904 and memory 906. For example only, and not by way of limitation, computer 902 may include a workstation, a laptop, or a hand-held device such as a cell phone or a personal digital assistant (PDA), a server (e.g., server 116), computer 110 (see FIG. 1), or any other processor-based device known in the art. In one embodiment, computer 902 may be operably coupled to a display (not shown in FIG. 9), which presents images to the user via a GUI. As will be appreciated, computer 902 may include one or controllers including one or more operating systems, which may be configured and/or updated in accordance with various embodiments disclosed herein.

Generally, computer 902 may operate under control of an operating system 908 stored in memory 906, and interface with a user to accept inputs and commands and to present outputs through a GUI module 910. Although GUI module 910 is depicted as a separate module, the instructions performing the GUI functions may be resident or distributed in the operating system 908, a program 912, or implemented with special purpose memory and processors. Computer 902 may also implement a compiler 914 that allows a program (e.g., code) 912 written in a programming language to be translated into processor 904 readable code. After completion, program 912 may access and manipulate data stored in memory 906 of computer 902 using the relationships and logic that are generated using compiler 914.

Further, operating system 908 and program 912 may include instructions that, when read and executed by computer 902, may cause computer 902 to perform the steps necessary to implement and/or use various embodiments of the disclosure. Program 912 and/or operating instructions may also be tangibly embodied in memory 906 and/or data communications devices, thereby making a computer program product or article of manufacture according to an embodiment of the present disclosure. As such, the term “program” as used herein is intended to encompass a computer program accessible from any computer readable device or media. Program 912 may exist on an electronic device (e.g., electronic device 113; see FIG. 1), a server (e.g., server 116; see FIG. 1), a mobile unit (e.g., mobile unit 102; see FIG. 1), and/or another device. Furthermore, portions of program 912 may be distributed such that some of program 912 may be included on a computer readable media within an electronic device (e.g., electronic device 113), some of program 912 may be included on a computer readable media on a server (e.g., server 116), some of program 912 may be included on a computer readable media on a surveillance unit (e.g., unit 102), and/or some of program 912 may be included on a computer readable media on another device. In some embodiments, program 912 may be configured to run on electronic device 113, server 116, unit 102, another computing device, or any combination thereof. As a specific example, program 912 may exist on server 116 and/or unit 102 and may be accessible to a user via electronic device 113.

The present disclosure relates to an integration service system and method that enables communication between video management systems and cloud-based devices by translating between different API protocols. Various embodiments may address the technical problem of incompatible communication protocols between legacy on-premise video management systems that use, for example, SOAP-based APIs and modern cloud native devices that utilize, for example, REST-based APIs, particularly for mobile surveillance units with private IP addresses on networks (e.g., cellular networks) that cannot directly interface with on-premise systems behind firewalls.

In one aspect, the disclosure provides a system comprising an integration service configured to communicatively couple between a video management system and a device, where the integration service is configured to translate a first simple object access protocol (SOAP) API call received from the video management system to a first representational state transfer (REST) API call, or translate a second REST API call received from the device to a second SOAP API call.

In one aspect, the integration service is further configured to receive the first SOAP API call from the video management system and convey the first REST API call to the device, while also receiving the second REST API call from the device and conveying the second SOAP API call to the video management system.

In one aspect, the integration service is configured to authenticate at least one of the video management system or the device for communication via the integration service, providing secure communication between the systems.

In one aspect, the device comprises a cloud device configured to receive the first REST API call, with the system further comprising a second device communicatively coupled to the cloud device and including at least one input device such as a camera, wherein the integration service enables the video management system to control the input device and any associated output devices.

According to another aspect of the present disclosure, an integration service is provided that is coupled between a video management system and a device, configured to receive a first SOAP API call from the video management system, translate the first SOAP API to a first REST API call, convey the first REST API call to the device, receive a second REST API call from the device, translate the second REST API to a second SOAP API call, and convey the second SOAP API call to the video management system.

In one aspect, the integration service is configured to authenticate each of the video management system and the device, ensuring secure bidirectional communication.

In one aspect, the device comprises a cloud device configured to control a component (e.g., sensor) of a second device responsive to receipt of the first REST API call, where the second device comprises a mobile unit and the sensor comprises a camera.

In one aspect, the integration service is coupled to the video management system and the device via metered connections, enabling communication with mobile units over, for example, cellular and/or satellite networks.

According to another aspect of the present disclosure, a method comprises receiving, at a proxy service, a first SOAP API call from a video management system, translating, via the proxy service, the first SOAP API to a first REST API call, and conveying the first REST API call from the proxy service to a device.

In one aspect, the method further comprises authenticating, via the proxy service, at least one of the video management system or the device to ensure secure communication.

In one aspect, conveying the first REST API call to the device comprises conveying the first REST API call to a cloud device, which responsively conveys a control signal from the cloud device to a mobile unit for controlling at least one sensor of the mobile unit via a metered connection.

In one aspect, the method further comprises receiving, at the proxy service, a second REST API call from the device, translating, via the proxy service, the second REST API to a second SOAP API call, and conveying the second SOAP API call from the proxy service to the video management system, enabling bidirectional communication and control.

Various embodiments may enable seamless integration between cloud native devices and legacy on-premise video management systems without requiring additional customer infrastructure, modernizing on-premise video management system platforms by making them REST API compatible, providing scalable solutions that support enterprise-grade implementations, and creating transparent integration (e.g., where the exchange appears like a conventional SOAP-based ONVIF-compliant camera to the VMS while communicating with cloud-based REST APIs).

Further areas of applicability will become apparent from the description provided herein. It should be understood that the description and specific examples are intended for purposes of illustration only and are not intended to limit the scope of the present disclosure.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system, comprising:
an integration service configured to communicatively couple between a video management system and a device;
the integration service further configured to at least one of:
translate a first simple object access protocol (SOAP) API call received from the video management system to a first representational state transfer (REST) API call; or
translate a second REST API call received from the device to a second SOAP API call.

2. The system of claim 1, wherein the integration service is further configured to at least one of:
receive the first SOAP API call from the video management system;
convey the first REST API call to the device;
receive the second REST API call from the device; and
convey the second SOAP API call to the video management system.

3. The system of claim 1, wherein the integration service is further configured to authenticate at least one of the video management system or the device for communication via the integration service.

4. The system of claim 1, wherein the device comprises a cloud device configured to receive the first REST API call, the system further comprising a second device coupled to the cloud device and including at least one input device, wherein the integration service enables the video management system to control the at least one input device.

5. The system of claim 4, wherein the at least one input device comprises a camera.

6. The system of claim 4, wherein the second device further comprises at least one output device, wherein the integration service enables the video management system to control the at least one output device.

7. The system of claim 4, wherein the second device comprises a mobile device.

8. An integration service coupled between a video management system and a device, the integration service configured to:
receive a first simple object access protocol (SOAP) API call from the video management system;
translate the first SOAP API to a first representational state transfer (REST) API call;
convey the first REST API call to the device;
receive a second REST API call from the device;
translate the second REST API to a second SOAP API call; and
convey the second SOAP API call to the video management system.

9. The integration service of claim 8, further configured to authenticate each of the video management system and the device.

10. The integration service of claim 8, wherein the device comprises a cloud device configured to control a sensor of a second device responsive to receipt of the first REST API call.

11. The integration service of claim 8, wherein the second device comprises a mobile unit and a sensor comprises a camera.

12. The integration service of claim 8, wherein the integration service is coupled to the video management system via a first metered connection and the integration service is coupled to the device via a second metered connection.

13. The integration service of claim 8, wherein the integration service is configured to at least one of communicatively couple to the video management system via at least one metered connection or communicatively couple to the device via the at least one metered connection.

14. The integration service of claim 8, wherein the first REST API call is for controlling at least one electronic device of a mobile unit communicatively coupled to the device via a metered connection.

15. A method, comprising:
receiving, at a proxy service, a first simple object access protocol (SOAP) API call from a video management system;
translating, via the proxy service, the first SOAP API to a first representational state transfer (REST) API call; and
conveying the first REST API call from the proxy service to a device.

16. The method of claim 15, further comprising authenticating, via the proxy service, at least one of the video management system or the device.

17. The method of claim 15, wherein conveying the first REST API call to the device comprises conveying the first REST API call to a cloud device.

18. The method of claim 17, further comprising conveying, responsive to receipt of the first REST API call at the cloud device, a control signal from the cloud device to a mobile unit for controlling at least one sensor of the mobile unit.

19. The method of claim 18, wherein conveying the control signal comprises conveying the control signal to the mobile unit via a metered connection.

20. The method of claim 15, further comprising:
receiving, at the proxy service, a second REST API call from the device;
translating, via the proxy service, the second REST API to a second SOAP API call; and
conveying the second SOAP API call from the proxy service to the video management system.
